(19) United States
(12) Patent Application Publication
(10) Pub. No.: US 2012/0154675 A1
(43) Pub. Date: Jun. 21, 2012

(54) FRAME INTERPOLATION APPARATUS AND METHOD

(76) Inventors: Osamu NASU, Tokyo (JP); Yoshiki Ono, Tokyo (JP); Toshiaki Kubo, Tokyo (JP); Naoyuki Fujiyama, Tokyo (JP); Tomoatsu Horibe, Tokyo (JP)

(21) Appl. No.: 13/291,585

(22) Filed: Nov. 8, 2011

(30) Foreign Application Priority Data
Dec. 16, 2010 (JP) 2010-280237

(51) Int. Cl. H04N 7/01

(52) U.S. Cl. 348/452; 348/E07.003

(57) ABSTRACT

To interpolate a frame between a first frame and a second frame in a video signal, a motion-compensated interpolated frame is generated and then corrected responsive to detection of a motion vector boundary. Positions at which an absolute value of a first or second derivative of the motion vectors is not less than a predetermined amount are found to be at a motion vector boundary, and the pixel values of the pixels in an area where boundary pixels are concentrated are corrected. Blocks with at least a predetermined proportion of boundary pixels are found to be in an area where boundary pixels are concentrated.

### 1. FIELD OF THE INVENTION

The present invention relates to a frame interpolation apparatus and method for smoothing motion in a video image by interpolating additional frames into the video signal. The invention also relates to a program used to implement the frame interpolation method and a recording medium in which the program is stored.

### 2. DESCRIPTION OF THE RELATED ART

Liquid crystal television sets and other image display apparatus of the hold type continue to display the same image for one frame period. A resulting problem is that the edges of moving objects in the image appear blurred, because while the human eye follows the moving object, its displayed position moves in discrete steps. A possible countermeasure is to smooth out the motion of the object by interpolating frames, thereby increasing the number of displayed frames, so that the displayed positions of the object change in smaller discrete steps as they track the motion of the object.

A related problem, referred to as judder, occurs when a television signal is created by conversion of a video sequence with a different frame rate, or a video sequence on which computer processing has been performed, because the same image is displayed continuously over two or more frames, causing motion to be blurred or jerky. This problem can also be solved by interpolating frames, thereby increasing the number of displayed frames.

Known methods of generating interpolated frames include motion compensated frame interpolation techniques in which motion vectors between two consecutive frames in an input video signal are estimated in order to generate an interpolated frame between them. Various motion compensation algorithms have been proposed, including block matching algorithms in which the current frame is partitioned into blocks of a given size and a motion vector is derived for each block by moving a block of the same size around on the previous frame to find a position with a minimum sum of absolute differences in pixel luminance. It is difficult, however, to derive accurate motion vectors from image information alone.

When the estimated motion vectors represent actual motion incorrectly, the interpolated frame generated from the motion vectors is marred by image defects. This problem is addressed by, for example, Mishima et al. in Japanese Patent Application Publication No. 2008-244846, in which the reliability of a motion vector is defined on the basis of pixel values, e.g., in terms of the similarity of the blocks from which the motion vector is derived. A motion vector of low reliability is treated as an incorrectly estimated motion vector that may impair image quality, and the interpolated frame is corrected by use of a separately prepared failure prevention image.

In conventional frame interpolation methods such as the one described in Japanese Patent Application Publication No. 2008-244846 that determine motion vector reliability from pixel values, however, local cyclic patterns, noise, and other factors that lead to incorrect motion vector estimation can also make it impossible to determine the reliability of the motion vectors accurately. Especially at the boundaries between regions of differing motion, the motion vector reliability estimated from image information becomes much lower than the actual level of image damage. In an area where the estimated reliability is lower than the actual image damage warrants, unnecessary corrections may cause the problem of blur, because the failure prevention image used to make the corrections is generally created by averaging the images in the preceding and following frames. Conversely, repeating patterns can produce incorrect motion vectors that are treated as highly reliable, because of the similarity of pixel values, in which case necessary corrections are not made and image defects are left unrepaired.

### SUMMARY OF THE INVENTION

An object of the present invention is to suppress image artifacts and generate substantially flicker-free, smooth motion video.

According to the invention, there is provided a frame interpolation apparatus for generating an interpolated frame between a first frame and a second frame in a video signal from a set of frames including at least the first frame and the second frame, the second frame temporally preceding the first frame, the frame interpolation apparatus comprising:

a motion vector estimator for deriving motion vectors between the first frame and the second frame, based on the set of frames;

an interpolated frame generator for generating a motion-compensated interpolated frame based on the motion vectors obtained by the motion vector estimator; and

an interpolated frame corrector for correcting the motion-compensated interpolated frame generated by the interpolated frame generator; wherein

the interpolated frame corrector includes a motion vector boundary detector for detecting positions where an absolute value of a first derivative or a second derivative of the motion vectors obtained by the motion vector estimator is not less than a predetermined amount as a motion vector boundary, and corrects the motion-compensated interpolated frame on a basis of the motion vector boundary detected by the motion vector boundary detector.

Image degradation is estimated and corrected in the present invention on the basis of the motion vector distribution. It is therefore possible to generate interpolated frames with few defects and obtain substantially flicker-free, smooth motion video.

### BRIEF DESCRIPTION OF THE DRAWINGS

In the attached drawings:

FIG. 1 is a block diagram illustrating the structure of a frame interpolation apparatus according to a first embodiment of the invention;

FIG. 2 is a block diagram illustrating an exemplary structure of the interpolated frame generator in FIG. 1;

FIG. 3 is a block diagram illustrating an exemplary structure of the interpolated frame corrector in FIG. 1;

FIG. 4 is a drawing illustrating a method of determining pixel values in a motion compensated interpolated frame;

FIG. 5 is a flowchart illustrating the flow of processing in the boundary concentration block detector in FIG. 3;

FIG. 6 illustrates an exemplary boundary concentration area centered on the geometric center of a boundary concentration block;

FIG. 7 illustrates an exemplary correction target area including a plurality of boundary concentration areas;

FIG. 8 illustrates another exemplary boundary concentration area centered on the geometric center of a boundary concentration block;

FIG. 9 illustrates yet another exemplary boundary concentration area centered on the geometric center of a boundary concentration block;

FIG. 10 illustrates still another exemplary boundary concentration area centered on the geometric center of a boundary concentration block

FIG. 11 is a diagram illustrating a method of calculating parameters defining the dimensions of a boundary concentration area;

FIG. 12 illustrates exemplary pixels included in two boundary concentration areas centered on the approximate geometric centers of two boundary concentration blocks;

FIG. 13 illustrates the distance from the center of a boundary concentration area to a pixel and the distance to the edge of the boundary concentration area in the same direction;

FIG. 14 is a schematic representation of the operation of the interpolated frame corrector; and

FIG. 15 is a block diagram illustrating an exemplary interpolated frame corrector used in a frame interpolation apparatus in a second embodiment of the invention.

### DETAILED DESCRIPTION OF THE INVENTION

### First Embodiment

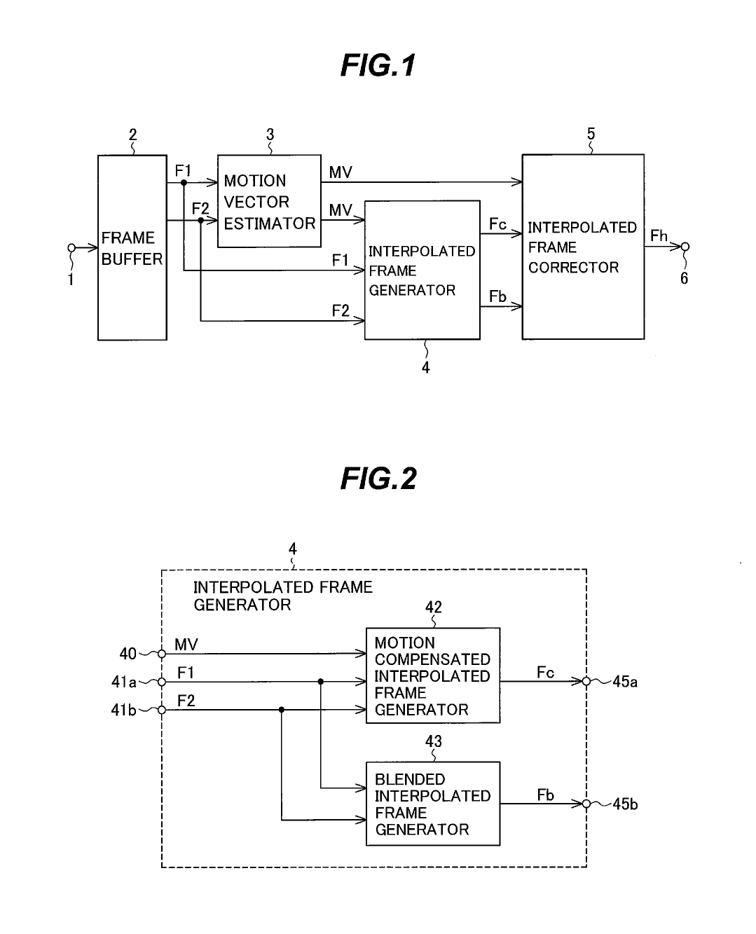

Referring to FIG. 1, the frame interpolation apparatus in the first embodiment includes a video input terminal 1, a frame buffer 2, a motion vector estimator 3, an interpolated frame generator 4, an interpolated frame corrector 5, and an interpolated frame output terminal 6.

A video signal input from the video input terminal 1 is stored in the frame buffer 2.

The motion vector estimator 3 receives first frame data F1 and second frame data F2 from the frame buffer 2 and outputs motion vectors MV. In the following description, the term “frame” may also be used to mean “frame data”. The first frame F1 is the latest (current) frame; the second frame F2 is the frame immediately preceding the first frame F1.

The interpolated frame generator 4 receives motion vectors MV from the motion vector estimator 3 and the first and second frames F1 and F2 read from the frame buffer 2, outputs a motion compensated interpolated frame Fc generated taking image motion into consideration, and also outputs a blended interpolated frame Fb generated by combining the first and second frames F1 and F2 in proportions corresponding to the temporal phase of the interpolated frame. The term ‘temporal phase’ refers to the position of the interpolated frame in the time domain, the interval between the first frame F1 and second frame F2 being treated as one period.

The interpolated frame corrector 5 receives the motion vectors MV from the motion vector estimator 3 and the interpolated frames Fb, Fc from the interpolated frame generator 4, uses the blended interpolated frame Fb to correct the motion compensated interpolated frame Fc according to the motion vectors MV, and outputs the corrected motion compensated interpolated frame via the interpolated frame output terminal 6 as a corrected interpolated frame Fh.

The interpolated frame generator 4 will be described with reference to FIG. 2. The interpolated frame generator 4 includes a motion vector input terminal 40, frame input terminals 41a and 41b, a motion compensated interpolated frame generator 42, a blended interpolated frame generator 43, a motion compensated interpolated frame output terminal 45a, and a blended interpolated frame output terminal 45b.

The motion vector input terminal 40 receives (data indicating) the motion vectors MV from the motion vector estimator 3. The frame input terminals 41a and 41b receive the first frame F1 and second frame F2, respectively, from the frame buffer 2.

The motion compensated interpolated frame generator 42 receives the motion vectors MV through the motion vector input terminal 40 and the first and second frames F1, F2 through the frame input terminals 41a, 41b, and outputs the motion compensated interpolated frame Fc through output terminal 45a. The blended interpolated frame generator 43 receives the first and second frames F1, F2 through the frame input terminals 41a, 41b, performs phase weighted blending (weighted average calculations), and outputs the blended interpolated frame Fb through output terminal 45b.

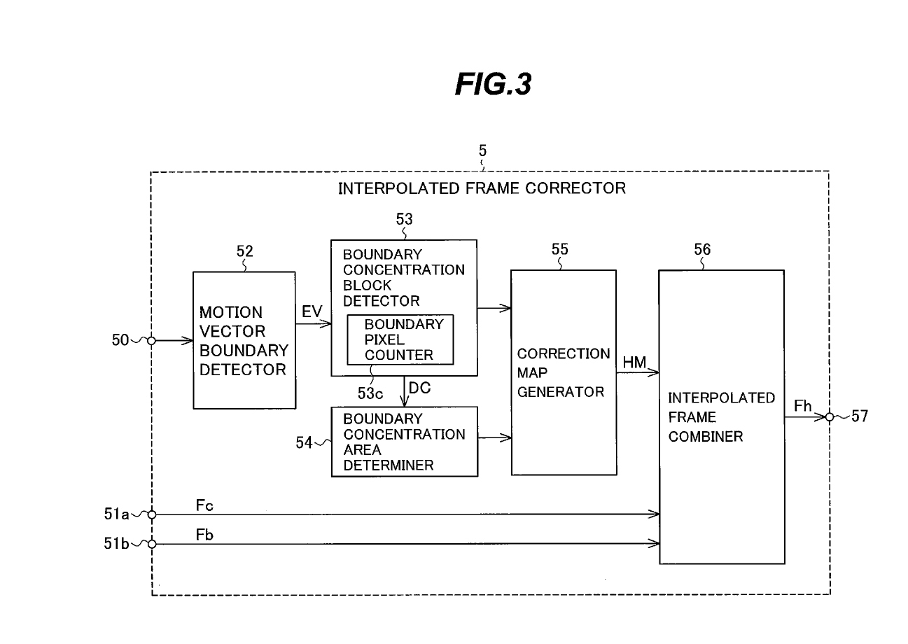

An exemplary structure of the interpolated frame corrector 5 will be described with reference to FIG. 3. The interpolated frame corrector 5 in FIG. 3 includes a motion vector input terminal 50, frame input terminals 51a and 51b, a motion vector boundary detector 52, a boundary concentration block detector 53, a boundary concentration area determiner 54, a correction map generator 55, an interpolated frame combiner 56, and a corrected interpolated frame output terminal 57.

The motion vector input terminal 50 receives the motion vectors MV output from the motion vector estimator 3. The frame input terminals 51a and 51b respectively receive the motion compensated interpolated frame Fc and the blended interpolated frame Fb output from the interpolated frame generator 4.

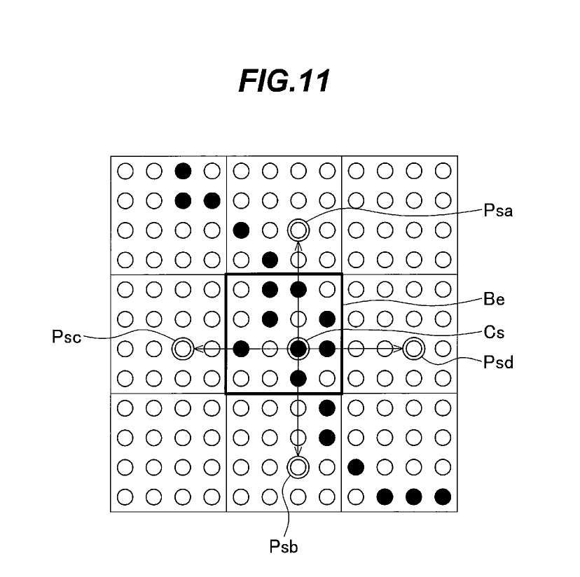

The motion vector boundary detector 52 receives the motion vectors MV through the motion vector input terminal 50 and outputs a boundary image EV consisting of pixels at motion vector boundaries. A motion vector boundary is determined to be located at a position at which an absolute value of a first derivative (first difference) or a second derivative (second difference) in the spatial direction is not less than a given threshold value, and pixels located at the boundary are detected as boundary pixels. An image consisting of the boundary pixels are treated as a motion vector boundary image EV. An example can be seen by referring to FIG. 11 later described, in which the black dots represent boundary pixels.

The boundary concentration block detector 53 receives the motion vector boundary image EV from the motion vector boundary detector 52 and outputs motion vector boundary concentration distribution information DC. For example, the boundary concentration block detector 53 determines whether each of the blocks, each forming a part of the frame, includes a prescribed proportion or greater of boundary pixels, and detects blocks meeting this criterion as boundary concentration blocks. The motion vector boundary intensity distribution information DC then indicates whether or not each block is a boundary concentration block.

The blocks forming part of the frame are formed by partitioning the frame into parts of a given size. In the exemplary description below, the motion vector boundary detector 52 partitions each frame into m blocks horizontally and n blocks vertically, making m×n blocks in all. Each block has a horizontal width of w pixels and a vertical height of h pixels or lines. Each block is identified by information such as a number assigned according to its location in the frame.

The boundary concentration area determiner 54 receives boundary concentration distribution information DC indicating boundary concentration blocks from the boundary concentration block detector 53 and determines or designates a boundary concentration area for each boundary concentration block. The boundary concentration area is so designated as to be centered at substantially the geometric center of the boundary concentration block, and may have either a predetermined size and shape or a size and shape determined from the motion vectors surrounding the boundary concentration block. The designation of the boundary concentration area may also be referred to a process of generating a new boundary concentration area within the frame. The boundary concentration area determiner 54 outputs information indicating these newly determined boundary concentration areas.

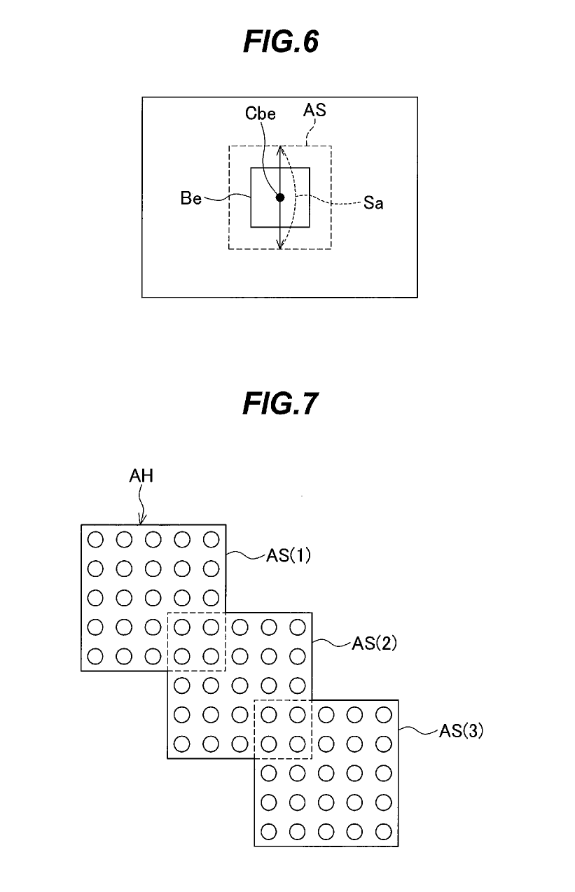

Exemplary boundary concentration areas will be described later by referring to FIGS. 6, 8, 9, and 10.

The correction map generator 55 receives the boundary concentration area information output from the boundary concentration area determiner 54 and generates an interpolated frame correction map HM. The interpolated frame correction map HM includes information indicating whether or not each pixel in the frame needs to be corrected (whether each pixel is a pixel targeted for correction). A pixel targeted for correction on the interpolated frame correction map HM will be referred to below as a target pixel. The interpolated frame correction map HM preferably also indicates the degree of correction to be applied to each target pixel, as described later.

The interpolated frame combiner 56 receives the interpolated frame correction map HM output from the correction map generator 55, the motion compensated interpolated frame Fc input through input terminal 51a, and the blended interpolated frame Fb input through input terminal 51b, and outputs the corrected interpolated frame Fh from output terminal 57.

The boundary concentration block detector 53, boundary concentration area determiner 54, correction map generator 55, and interpolated frame combiner 56 thus cooperate to correct the motion compensated interpolated frame Fc generated by the interpolated frame generator 4 by correcting pixels (pixel values) located in boundary concentration areas where relatively many boundary pixels are detected by the motion vector boundary detector 52.

The flow of processing in the first embodiment will now be described.

The first and second frames F1 and F2 among the frames stored in the frame buffer 2 are sent to the motion vector estimator 3, which derives motion vectors MV between the first and second frames F1 and F2. Block matching will be described next as a typical motion vector estimation method or algorithm.

In a block matching method or algorithm, one of the two frames is partitioned into blocks of a given size and a motion vector MV is derived for each block. In the following description the second frame F2 is partitioned into blocks. The frame is partitioned into p blocks in the horizontal direction and q blocks in the vertical direction, each block including s pixels in the horizontal direction and t pixels (t lines) in the vertical direction. The number of blocks (p×q) and block size (s×t) may or may not be equal to the number of blocks (m×n) and block size (w×h) used by the boundary concentration block detector 53.

In order to derive a motion vector for a block (target block) in the second frame F2, the similarity of the image pattern of the target block to the image pattern of a reference block of the same size as the target block but disposed on the first frame F1 is determined. Although similarity can be defined in various ways, generally the sum of absolute differences (SAD) of luminance values of corresponding pixels in the two blocks is used. The polarity of the sum may be reversed by subtracting the sum from a prescribed value so that higher values indicate greater similarities.

For each target block, the reference block is shifted to different positions, a similarity is calculated at each position, and a motion vector MV is determined from the position giving the highest similarity, i.e., the relative position of the reference block giving the highest similarity in relation to the target block. Ideally, the reference block is shifted to every possible position in the entire frame, but calculating similarities at all positions in the frame requires an enormous amount of computation, so the reference block is generally shifted within a given range centered on the position of the target block.

A block matching algorithm may use all pixels in the two blocks, or only some of the pixels. For example, an area near the center of each target block on the second frame F2 may be designated as a target area, and similarity may be calculated from the pixels in the target area and the pixels of a reference area of the same size in the first frame F1.

This process is repeated for all blocks in the second frame F2 to derive block-level motion vectors MV between the first and second frames F1 and F2.

The block matching algorithm yields motion vectors MV of respective blocks (block-level motion vectors MV. Next motion vectors of respective pixels (pixel-level motion vectors) are derived from the block-level motion vectors. There are various methods of deriving pixel-level motion vectors, and any of them may be used. The simplest method is to assign the value of the motion vector MV of each block to all the pixels in the block. When the block size is small enough, the assumption that all pixels in the block have the same motion vector MV has little effect on the quality of interpolated frames generated from the motion vectors MV. Other methods may also be used to derive pixel-level motion vectors from the block-level motion vectors MV.

Block matching has been described as one exemplary method that may be used to derive motion vectors MV in the motion vector estimator 3, but any other suitable method may be used instead.

On the basis of the motion vectors MV derived by the motion vector estimator 3, the motion compensated interpolated frame generator 42 in the interpolated frame generator 4 generates a motion compensated frame Fc between the first and second frames F1 and F2. The blended interpolated frame generator 43 in the interpolated frame generator 4 generates a blended interpolated frame Fb from the first and second frames F1 and F2. In the following explanation, both interpolated frames Fb, Fc are assumed be temporally centered between the first and second frames F1 and F2.

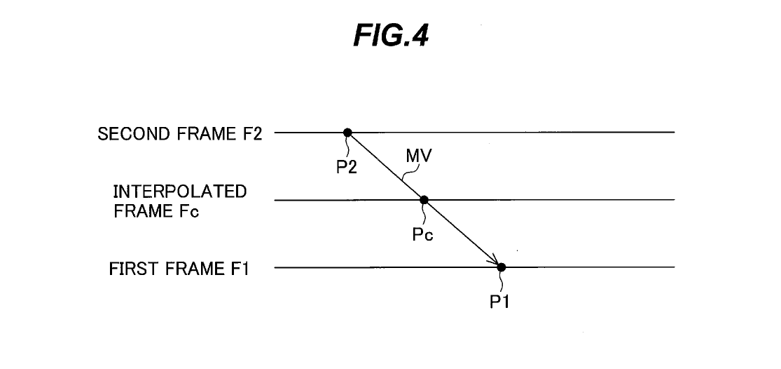

The motion compensated interpolated frame generator 42 generates the motion compensated interpolated frame Fc according to the motion vectors MV between the first and second frames F1 and F2. The pixel values in the motion compensated interpolated frame Fc can be determined as illustrated in FIG. 4.

In FIG. 4, pixel P2 in the second frame F2 shifts to the position of pixel Pc on the motion compensated interpolated frame Fc and then to the position of pixel P1 on the first frame F1 over time. Thus, pixels P2, Pc, and P1 should have the same pixel value. Accordingly, the value of pixel Pc in the motion compensated interpolated frame Fc is determined from the values of pixels P2 and P1. The average of the pixel values of pixel P2 and pixel P1 is taken as the value of pixel Pc on the grounds that the pixel value may vary over time.

The description just given assumes that the motion compensated interpolated frame Fc is temporally centered between the first and second frames F1 and F2, but frame Fc may be located at any other temporal position between frames F1 and F2. In that case, the pixel values in the motion compensated interpolated frame Fc are determined by weighted averaging according to the internal division ratio of the position between the first and second frames F1 and F2, instead of by simple averaging of the pixels on the first and second frames F1 and F2. That is, the pixel values on the motion compensated interpolated frame Fc are expressed by the following equation (1).

$$Pc ( x + \frac{d 2 \times MVx ( x , y )}{d 1 + d 2} , y + \frac{d 2 \times MVy ( x , y )}{d 1 + d 2} ) = \frac{d 1}{d 1 + d 2} P 2 ( x , y ) + \frac{d 2}{d 1 + d 2} P 1 ( x + MVx ( x , y ) , y + MVy ( x , y ) ) \qquad ( 1 )$$

In this equation, Pc(x, y) indicates the pixel value at the position with coordinates (x, y) in the motion compensated interpolated frame Fc; P1(x, y) indicates the pixel value at the position with coordinates (x, y) on the first frame F1; P2(x, y) indicates the pixel value at the position with coordinates (x, y) on the second frame F2; MVx(x, y) and MVy(x, y) indicate the x and y components of the motion vector MV originating at coordinates (x, y) on the second frame F2. The motion compensated interpolated frame Fc is located at the temporal point that divides the interval between frames F1 and F2 in the ratio d2:d1 (the ratio between the interval from F2 to Fc and the interval from Fc to F1 is d2:d1).

The blended interpolated frame generator 43 performs phase weighted averaging (blending) of the first and second frames F1 and F2 without using the motion vectors MV, and outputs the resulting frame as the blended interpolated frame Fb. Phase weighted averaging is a process that blends the frames by weighting them according to the phase of the interpolated frame. The pixel values Pb of the blended interpolated frame Fb can be obtained by the operation expressed by the following equation (2).

$$Pb ( x , y ) = \frac{d 1}{d 1 + d 2} P 2 ( x , y ) + \frac{d 2}{d 1 + d 2} P 1 ( x , y ) \qquad ( 2 )$$

In this equation, Pb(x, y) indicates the pixel value at the position with coordinates (x, y) on the blended interpolated frame Fb; P1(x, y) indicates the pixel value at the position with coordinates (x, y) on the first frame F1; P2(x, y) indicates the pixel value at the position with coordinates (x, y) on the second frame F2. The phase of the blended interpolated frame Fb is equivalent to the above ratio d2:d1 indicating how it divides the temporal interval between the second and first frames F2 and F1.

If the blended interpolated frame Fb is located halfway between the first and second frames F1 and F2 (d1=d2), equation (2) simplifies to

$$Pb ( x , y ) = \frac{P 2 ( x , y ) + P 1 ( x , y )}{2} \qquad ( 2 b )$$

and the blended interpolated frame Fb is obtained by a simple averaging calculation.

The interpolated frame corrector 5 detects interpolation defects and failures in the motion compensated interpolated frame generated by the interpolated frame generator 4, and performs corrections to make these defects and failures less noticeable in the motion video.

The motion vector boundary detector 52 detects boundaries among the motion vectors MV on the interpolated frame at the pixel level. The motion vectors on the interpolated frame can be determined from the motion vectors on the second frame F2. For instance, the motion vector at the position of pixel P2 on the second frame F2, as shown in FIG. 4 can be used as the motion vector at the position of pixel Pc on the interpolated frame. Motion vector boundaries can be detected by a method using a Laplacian filter. A Laplacian filter applied to pixel values is expressed by equation (3) below.

G(x,y)=P(x−1,y)+P(x,y−1)+P(x+1,y)+P(x,y+1)−4P(x,y) (3)

In this equation, G(x, y) indicates the second derivative value (second difference value) at the position with coordinates (x, y); P(x, y) indicates the pixel value at the position with coordinates (x, y). It is assumed that the x- and y-coordinate values are integers, and the difference between the coordinate values at mutually adjacent pixel positions is unity (1). These assumptions also apply in the equations below.

Motion vector boundaries are detected by taking the sum of absolute values of the second derivatives of the x and y components of the motion vectors MV, as expressed by the following equation (4), rather than by taking the second derivatives of the pixel values as in the above equation (3).

$$\begin{matrix}Gx ( x , y ) = MVx ( x - 1 , y ) + MVx ( x , y - 1 ) + MVx ( x + 1 , y ) + \\ MVx ( x , y + 1 ) - 4 MVx ( x , y ) Gy ( x , y ) \\ = MVy ( x - 1 , y ) + MVy ( x , y - 1 ) + MVy ( x + 1 , y ) + \\ MVy ( x , y + 1 ) - 4 MVy ( x , y ) G ( x , y ) \\ = \vert Gx ( x , y ) \vert + \vert Gy ( x , y ) \vert\end{matrix} \qquad ( 4 )$$

In these equations, MVx(x, y) and MVy(x, y) indicate the x and y components of the motion vector at the position with coordinates (x, y).

A motion vector boundary can be detected by determining pixels with an absolute value of second derivatives G(x, y) exceeding a prescribed threshold value to be boundary pixels, and pixels with second derivatives smaller than the threshold value to be non-boundary pixels. The motion vector boundary image EV is created as, for example, a binary frame in which boundary pixels are assigned the value ‘1’ and non-boundary pixels are indicated by the value ‘0’, and is output to the boundary concentration block detector 53 to indicate the boundary pixel distribution.

The above motion vector boundary detection process is performed by use of a Laplacian filter, but another type of filter, such as a Sobel filter, may be used to determine the first derivative (first difference). In summary, it is sufficient to detect the region with an absolute value of a first or second derivative being not less than a predetermined value, as a boundary region. Instead of the simple sum of the absolute values of the x and y components of the first or second derivative, a weighted sum may be used. For example, a sum weighted according to the values of the x and y components of the motion vector MV may be used, as expressed by the following equation (5).

$$G ( x , y ) = \frac{MVx ( x , y )}{MVx ( x , y ) + MVy ( x , y )} \vert Gx ( x , y ) \vert + \frac{MVy ( x , y )}{MVx ( x , y ) + MVy ( x , y )} \vert Gy ( x , y ) \vert \qquad ( 5 )$$

Alternatively, a sum weighted in the reciprocal ratio of the values of the x and y components of the motion vector MV may be used, as expressed by the following equation (6).

$$G ( x , y ) = \frac{MVy ( x , y )}{MVx ( x , y ) + MVy ( x , y )} \vert Gx ( x , y ) \vert + \frac{MVx ( x , y )}{MVx ( x , y ) + MVy ( x , y )} \vert Gy ( x , y ) \vert \qquad ( 6 )$$

On the basis of the output from the motion vector boundary detector 52, the boundary concentration block detector 53 detects boundary pixel concentration blocks (blocks including relatively many boundary pixels) and outputs information indicating whether each block is a boundary concentration block Be. As noted above, a boundary pixel concentration block may be detected from the proportion of boundary pixels in the block. If the proportion of the boundary pixels is equal to or greater than a prescribed value, the block is determined or designated to be a boundary concentration block. If the number of pixels per block is fixed, the number of boundary pixels in the block may be used instead of the proportion of boundary pixels.

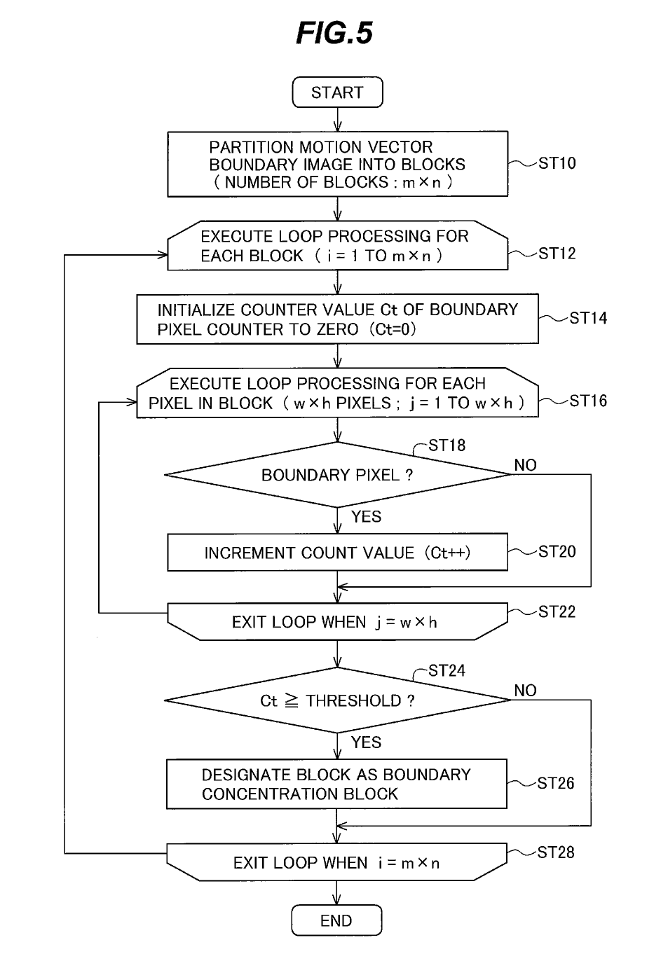

The processing flow in the boundary concentration block detector 53 will be described with reference to the flowchart in FIG. 5.

First, in step ST10, the motion vector boundary image EV is partitioned into blocks, for example, m×n blocks.

Then, starting in step ST12, a loop is executed to decide whether there is a boundary pixel concentration in each of the partitioned blocks (whether the number of boundary pixels included in each block is equal to or greater than a prescribed value). The loop starting in step ST12 is iterated until all blocks in the frame have been processed (i has reached (m×n)), as determined in step ST28.

In step ST14, a count value Ct maintained by a boundary pixel counter 53c in the boundary concentration block detector 53 is reset to zero (0). Whether each pixel in the block is a boundary pixel or not is then decided in the loop starting in step ST16. The loop starting in step ST16 is iterated until it is decided in step ST22 that all pixels in the block have been processed (j has reached (w×h)).

In the loop that starts in step ST16, first, in step ST18, a decision is made as to whether the pixel currently being processed is located on a boundary or not (is a boundary pixel or not). If the pixel is a boundary pixel, the count value Ct maintained by the boundary pixel counter 53c is incremented by one (1) in step ST20.

Next, in step ST24, whether the count value Ct is equal to or greater than a prescribed threshold value or not is decided, and if Ct is equal to or greater than the threshold value, the block is found to be a boundary concentration block Be, and information indicating that the block is a boundary concentration block Be is recorded in step ST26.

Through block partitioning and calculation of the boundary pixel concentration of each block as described above, the motion vector boundary concentration can be evaluated easily.

As described earlier, when the boundary concentration area determiner 54 receives information indicating a boundary concentration block Be from the boundary concentration block detector 53, it determines a boundary concentration area for each boundary concentration block. From the information indicating the boundary concentration block Be, the boundary concentration area determiner 54 defines a boundary concentration area AS having a center Cs located at or close to the center (geometric center) of the boundary concentration block Be. For a rectangular block, the intersection of its diagonals is the geometric center of the block.

For example, in FIG. 6 the center Cbe of the boundary concentration block Be is taken as the center Cs of the boundary concentration area AS. The boundary concentration area AS has a given size and shape, such as a square shape with a prescribed side length Sa.

If the geometric center of a block does not match any pixel position, the pixel position nearest to the geometric center (if a plurality of nearest pixel positions exist, any one of them) may be set as the center Cs of the boundary concentration area. If the blocks have a side length corresponding to an even numbers of pixels, for example, the geometric center does not match a pixel position. In that case, the pixel position or one of the pixel positions nearest to the geometric center is set as the center Cs of the boundary concentration area. In a coordinate system where the coordinates of pixel positions are represented by integers, if the calculated center coordinates are not integers, the coordinates of the nearest pixel position are determined by rounding non-integer values off to the nearest whole number. It is not strictly necessary to select the pixel position nearest the geometric center; coordinates obtained by any prescribed rounding process, such as rounding up, may be set as the coordinates of the center Cs of the boundary concentration area.

The correction map generator 55 receives the information indicating the boundary concentration area AS output from the boundary concentration area determiner 54, and generates a correction map HM showing the distribution of target pixels, indicating whether each pixel is to be corrected or not. The target pixels are pixels located in areas in which defects in the motion compensated interpolated frame Fc need to be corrected.

Suppose, for example, that the boundary concentration area determiner 54 determines a boundary concentration area AS for each boundary concentration block Be as shown in FIG. 6, so that the boundary concentration area AS is a square of side length Sa having a center Cs located at the center Cbe of the boundary concentration block Be. The correction map generator 55 treats all pixels included in the boundary concentration areas AS defined by the boundary concentration area determiner 54 as target pixels; the set of all these pixels forms the correction target area AH.

FIG. 7 shows an example in which the correction target area AH is formed by three boundary concentration areas AS(1) to AS(3). The correction map HM indicates whether each pixel in the image is located in the correction target area AH or not, in other words, whether each pixel is a target pixel or not, as described earlier, and preferably indicates the degree to which each pixel is to be corrected.

Whenever a boundary concentration block is recognized and a boundary concentration area AS is generated, the pixels in the generated boundary concentration area AS are stored in the correction map HM (that is, the correction map HM is updated). The correction map HM of the entire frame is completed when all blocks in the frame have been tested to decide whether they are boundary concentration blocks or not and boundary concentration areas have been generated for all the boundary concentration blocks.

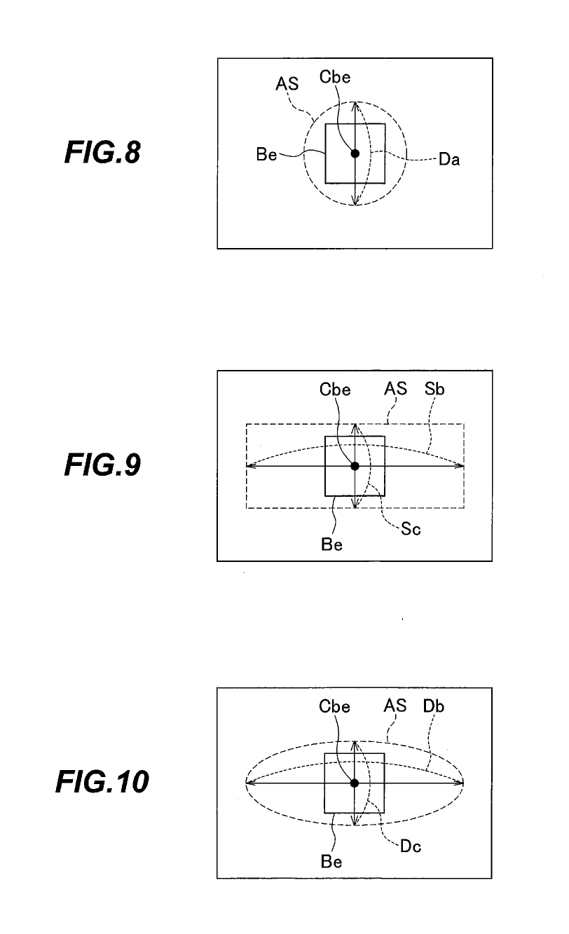

The boundary concentration area AS need not be square as shown in FIG. 6; it may be circular as shown in FIG. 8.

If the side length of the square or the diameter of the circle is twice the block side length, then when two adjacent blocks are both boundary concentration blocks, their boundary concentration areas join together, eliminating discontinuities. Values other than twice the block side length may also be used.

For example, the size of the boundary concentration area may be set equal to the block size, and the area occupied by each boundary concentration block may be set as a boundary concentration area. This eliminates the need for a separate boundary concentration area determiner 54; information indicating the center Cbe of each boundary concentration block detected in the boundary concentration block detector 53 may be supplied from the boundary concentration block detector 53 to the correction map generator 55 as information indicating the center of a boundary concentration area. That is, the boundary concentration block detector 53 also functions as the boundary concentration area determiner 54.

However, if the size of the boundary concentration area is made independent of the block size, as described above, then corrections can be performed in an appropriate area regardless of the size and shape of the blocks used to calculate motion vector concentration.

To enable more effective correction, the size (square side length Sa, circle diameter Da, etc.) of the boundary concentration area for each block may be determined from the distribution of motion vectors around the block.

When the size of the boundary concentration area is determined from the motion vector distribution, the boundary concentration area may be rectangular as shown in FIG. 9. Although FIG. 9 shows a horizontally-elongated rectangular shape and FIG. 10 shows a horizontally-elongated ellipse, the shape and the direction or elongation need not be predetermined; they may be determined according to the distribution of motion vectors in or around the boundary concentration area AS.

The dimensions (side lengths Sb, Sc or major and minor axis lengths Db and Dc) of a rectangular or elliptical boundary concentration area may also be determined from the motion vectors in or around the boundary concentration area AS.

An exemplary method of determining the horizontal and vertical axes Dx and Dy of an elliptical boundary concentration area will now be described with reference to FIG. 11, in which white dots indicate non-boundary pixels and black dots indicate boundary pixels.

In this example the approximate center pixel position of the boundary concentration block Be is taken as the center Cs of the boundary concentration area, and the motion vectors of pixels Psa, Psb, Psc, Psd located at prescribed distances upward, downward, leftward, and rightward from the center Cs of the boundary concentration area are used. For example, the absolute difference |MVy(Psa)−MVy(Psb)| between the vertical components (y components) MVy(Psa) and MVy(Psb) of the motion vectors MV of the pair of pixels Psa, Psb located upward and downward at the described distance is calculated, and a value obtained by doubling this absolute difference is taken as the length of the vertical axis Dy (extending in the y direction) of the ellipse. That is, Dy is determined by the following equation.

Dy=2×|MVy(Psa)−MVy(Psb)|

Similarly, the absolute difference between the horizontal components (x components) MVx(Psc) and MVx(Psd) of the motion vectors MV of the pair of pixels Psc, Psd located leftward and rightward at the described distance is calculated, and a value obtained by doubling this absolute difference is taken as the length of the horizontal axis Dx (extending in the x direction) of the ellipse. That is, Dx is determined by the following equation.

Dx=2×|MVx(Psc)−MVx(Psd)|

These dimensions define the area of the ellipse.

The long and short side lengths of a rectangular area may be determined in the same way. A more appropriate definition of the set of pixels to be corrected becomes possible when the size of the boundary concentration area is determined in this way from peripheral motion vectors MV.

In the above example, the sizes (rectangular side lengths or elliptical axis lengths) of the boundary concentration area are obtained by multiplying the difference between the motion vectors of pixels located at prescribed distances from the center by two, but a factor other than two may be used.

The boundary concentration area may have a shape other than a rectangular shape (such as a square shape or a rectangular shape with unequal adjacent sides), or a circular shape, or a elliptical shape.

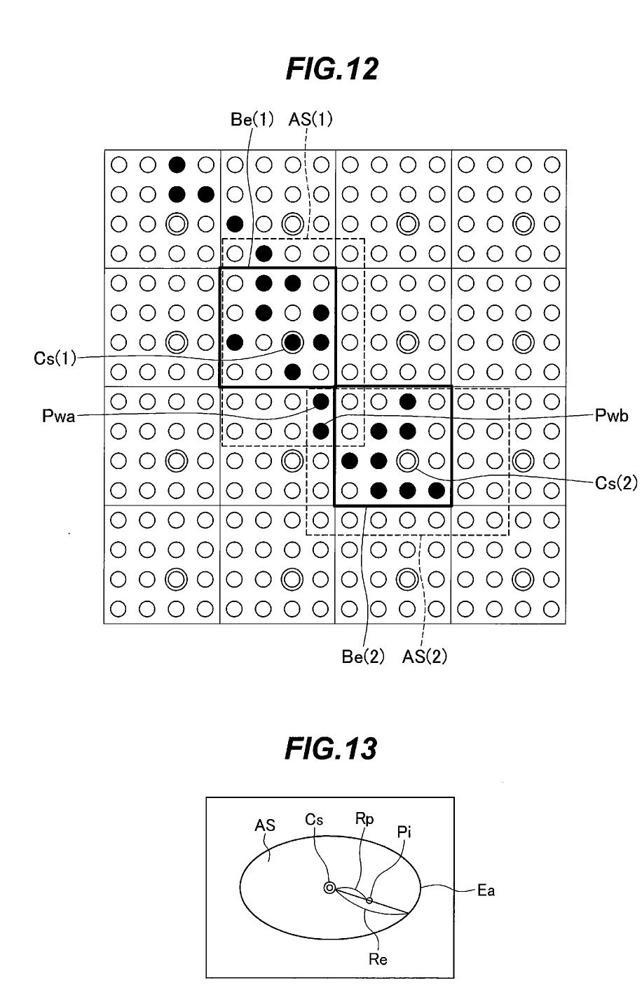

When a plurality of boundary concentration blocks are detected in the frame and a plurality of corresponding boundary concentration areas are generated, a pixel in the frame included in any one or more of the boundary concentration areas is treated as a pixel to be corrected. FIG. 12 shows an example in which pixels Pwa and Pwb fall in two boundary concentration areas AS(1) and AS(2). The two boundary concentration areas AS(1) and AS(2) have respective centers Cs(1) and Cs(2) near the centers of blocks Be(1) and Be(2).

In the completed correction map HM of the entire frame image, each pixel is labeled as a target pixel (pixel to be corrected) or a non-target pixel. It is possible to correct target pixels in a single uniform way and not to correct non-target pixels at all, but that will cause the boundary between an area with corrected pixels and an area with uncorrected pixels to become a false edge, leading to reduced image quality. An effective way to prevent this is to create a correction map HM with a correction degree distribution in which the degree of correction to be performed gradually decreases from the center portion of the target area toward its periphery (the boundary between the target area and the surrounding non-target area). The degree of correction referred to here is a mixing ratio in which the blended interpolated frame and the motion compensated interpolated frame are combined. When the degree of correction is zero (0) the blended interpolated frame is not used at all; when the degree of correction is unity (1) or 100%, only the blended interpolated frame is used.

Suppose, for example, that the degree of correction of each pixel Pi is calculated whenever a boundary concentration area is generated, based on the ratio (Rw) of the distance (Rp) from the center Cs of the boundary concentration area AS to the pixel Pi to the distance (Re) from the center Cs of the boundary concentration area AS to the edge Ea of the boundary concentration area AS in the direction of the pixel Pi. FIG. 13 shows examples of these distances Rp, Re.

For example, a degree of correction Dh expressed in percent is given by the following equation.

Dh=100×(1−Rp/Re)

The degree of correction need not decrease linearly in proportion to the distance; it only needs to decrease monotonically with respect to the distance.

In using degrees of correction, the boundary concentration area determiner 54 outputs not only information defining a boundary concentration area AS but also information indicating a degree of correction Dh for each pixel in the boundary concentration area, based on which the correction map generator 55 generates a correction map HM including the degree of correction Dh of each target pixel in the target area.

There may be frame images in which a plurality of different degrees of correction are calculated for a pixel included in a plurality of detected boundary concentration areas AS. In that case, the maximum of the calculated degrees is treated as the degree of correction of the pixel. In FIG. 12, for example, if the degree of correction of pixel Pwa calculated from its belonging to boundary concentration area AS(1) is Dh(1) and the degree of correction of the pixel Pwa calculated from its belonging to boundary concentration area AS(2) is Dh(2), the greater one of Dh(1) and Dh(2) is used as the degree of correction for pixel Pwa. The correction map generator 55 compares each newly calculated degree of correction Dh with the existing degree of correction, if any, for the same pixel in the correction map HM, and if the newly calculated degree is greater than the existing degree, the existing degree is replaced with the newly calculated degree.

The correction carried out on the motion compensated interpolated frame Fc by using a correction map HM in which each pixel has a degree of correction will now be described.

The interpolated frame combiner 56 receives the interpolated frame correction map HM (including information indicating whether each pixel is a target pixel or not and information indicating the degrees of correction of the target pixels), the motion compensated interpolated frame Fc, and the blended interpolated frame Fb, and corrects the motion compensated interpolated frame Fc by combining it with the blended interpolated frame Fb, more specifically, by mixing the pixel value of each target pixel indicated by the correction map HM with the corresponding pixel in the blended interpolated frame Fb in a mixing ratio corresponding to the degree of correction of the pixel. This operation is expressed by the following equation (7).

$$Ph ( x , y ) = \frac{( 100 - Dh ( x , y ) )}{100} Pc ( x , y ) + \frac{Dh ( x , y )}{100} Pb ( x , y ) \qquad ( 7 )$$

In this equation, Ph(x, y) indicates the pixel value at the position with coordinates (x, y) in the corrected interpolated frame Fh; Dh(x, y) indicates the degree of correction (expressed in percent) at the position with coordinates (x, y); Pc(x, y) indicates the pixel value at the position with coordinates (x, y) in the motion compensated interpolated frame Fc; Pb(x, y) indicates the pixel value at the position with coordinates (x, y) in the blended interpolated frame Fb.

The above mixing may be thought of as a process in which the values in the motion compensated interpolated frame Fc corresponding to the pixels to be corrected indicated in the correction map HM are partially or entirely replaced by the corresponding pixel values in the blended interpolated frame Fb.

This processing is not carried out for pixels other than the pixels to be corrected; for these pixels, the pixel values in the motion compensated interpolated frame are directly output as the pixels in the corrected interpolated frame Fh.

By use of the blended interpolated frame, the motion compensated interpolated frame Fc can be corrected in a natural way.

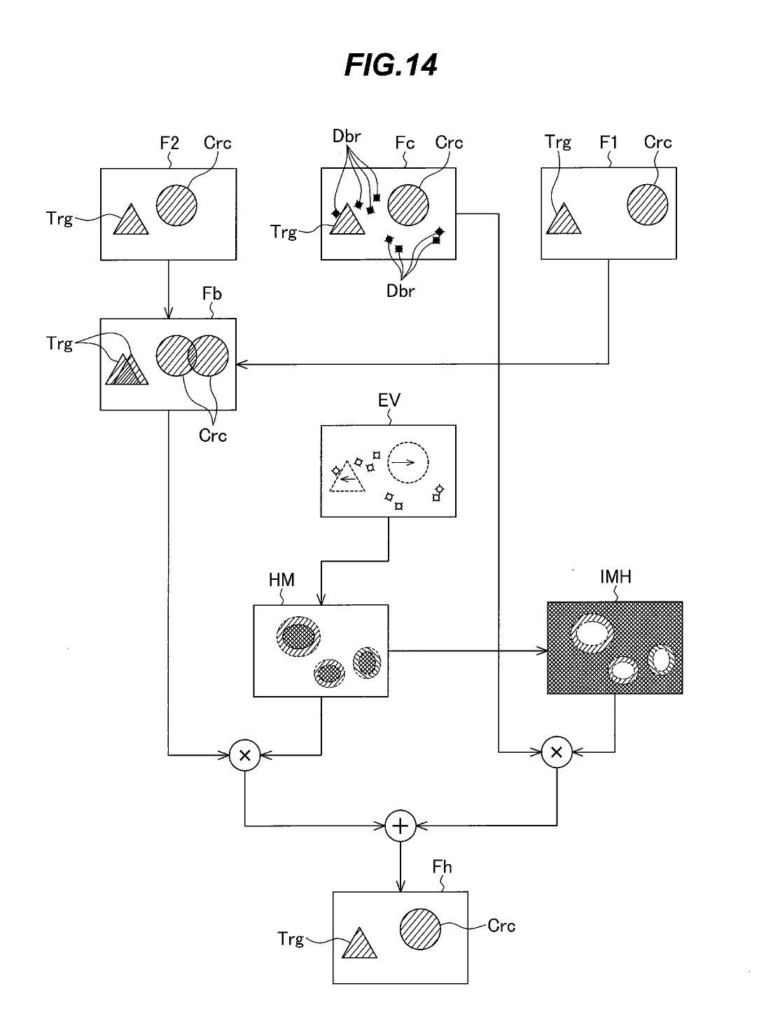

The processing flow in the interpolated frame corrector 5 is schematically shown in FIG. 14. The circle Crc and triangle Trg in the frame images in the drawing are objects that move to the right and left, respectively, in the period of time from the second frame F2 to the first frame F1. In the motion compensated interpolated frame Fc between the first frame F1 and second frame F2, there are artifacts Dbr that have presumably occurred due to incorrect estimation of motion vectors MV.

The blended interpolated frame Fb is generated from the first and second frames F1, F2 by the blended interpolated frame generator 43. The motion vector boundary detector 52 detects boundaries in the distribution of motion vectors MV and outputs the motion vector boundary image EV.

Based on the motion vector boundary image EV, the boundary concentration block detector 53, boundary concentration area determiner 54, and correction map generator 55 cooperate to generate the correction map HM indicating target area to be corrected, which is formed of areas (boundary concentration areas) in which motion vector boundary pixels are concentrated.

In this process, greater degrees of correction are assigned to pixels closer to the central portions of the target area, and the correction map HM also holds information indicating a degree of correction for each pixel.

The pixel values in the corrected interpolated frame Fh are obtained as sums of products of the pixel values in the blended interpolated frame Fb and the degrees of correction indicated by the correction map HM and products of the pixel values in the motion compensated interpolated frame Fc and the degrees of non-correction indicated in a non-correction map (inverted correction map) IHM obtained by reversing the correction map HM (so that the sum of the degree of correction and the degree of non-correction of each pixel is 100%). In FIG. 14, the degrees of correction in the correction map HM and the degrees of non-correction in the inverted correction map IHM are depicted in two levels by plain hatching and cross-hatching, but the degrees of correction and non-correction may have more levels.

The above sum-of-products operation is carried out for each pixel. For each pixel in the interpolated frame, a sum of the product of the degree of correction in the correction map HM and the pixel value in the blended interpolated frame Fb and the product of the degree of non-correction in the inverted correction map IHM and the pixel value in the motion compensated interpolated frame Fc is calculated.

Treatment of areas of motion vector (MV) boundary concentration as areas with image defects, as described above, enables the image defects to be detected with greater accuracy, thereby blocking the influence of noise, local cyclic patters, and other factors. The motion vector boundary concentration can be calculated easily and with high precision by block partitioning and by using the number of motion vector boundary pixels in each of the partitioned blocks.

When the detected image defects are corrected, the corrections can be performed in necessary and sufficient areas by setting the center (geometric center) of each block with a boundary pixel concentration as the center of a boundary concentration area.

The boundary concentration area can be defined more effectively by taking surrounding motion vectors MV into consideration.

In addition, corrections can be carried out without causing artificial noise at the boundaries between corrected and non-corrected areas if degrees of correction that decrease monotonically from the centers to the boundaries of the boundary concentration areas are assigned to the pixels so that the degree of correction changes smoothly.

### Second Embodiment

A second embodiment of the invention will now be described.

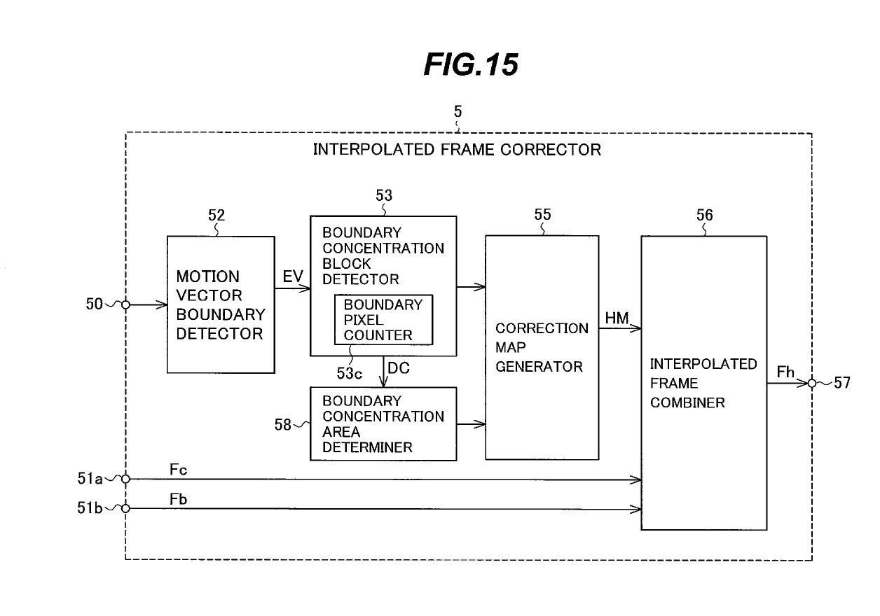

The general structure of the frame interpolation apparatus in the second embodiment is the same as shown in FIG. 1, but the internal structure of the interpolated frame corrector 5 is different. The boundary concentration area determiner 54 in the interpolated frame corrector 5 shown in FIG. 3 is replaced in the second embodiment by the different boundary concentration area determiner 58 shown in FIG. 15.

The boundary concentration area determiner 54 in FIG. 3 finds the geometric center of each block, but the boundary concentration area determiner 58 sets the gravimetric center Cw of each block as the center Cs of the corresponding boundary concentration area.

The gravimetric center Cw of each boundary concentration block Be is located within the block and is found by considering each pixel value of the block in the motion vector boundary image EV as a weight. The coordinates (x_{cw}(Bᵢ), y_{cw}(Bᵢ)) of the gravimetric center Cw are expressed by, for example, the following equation (8).

$${x}_{cw} ( {B}_{i} ) = \frac{1}{N} {\sum }_{( x , y ) ∈ {B}_{i}} e ( x , y ) x \\ {y}_{cw} ( {B}_{i} ) = \frac{1}{N} {\sum }_{( x , y ) ∈ {B}_{i}} e ( x , y ) x \\ e ( x , y ) = \{ \begin{matrix}1 : ( ( x , y ) ∈ E ) \\ 0 : ( ( x , y ) ∉ E )\end{matrix} \qquad ( 8 )$$

In this equation, N indicates the number of pixels in the block, and E indicates the set of boundary pixel coordinates in the block.

As described above, a boundary pixel has the value ‘1’ and a non-boundary pixel has the value ‘0’ in the motion vector boundary image EV, so the gravimetric center Cw of block Bi is also the gravimetric center of all the boundary pixels in the block.

The correction map generator 55 receives information defining the boundary concentration areas output from the boundary concentration area determiner 54 and carries out the same processing as the correction map generator 55 in the first embodiment.

By the use the gravimetric center Cw of a motion vector boundary concentration block as the center of the boundary concentration area as described above, it is possible to calculate the positions of image defects more precisely and determine more appropriate boundary concentration areas, thereby enabling more effective correction.

When the gravimetric center Cw does not match a pixel position, the pixel position nearest to the gravimetric center Cw (if a plurality of nearest pixel positions exist, any one of them) may be set as the center Cs of the boundary concentration area. In a coordinate system in which the coordinates of pixel positions are expressed by integers, if the coordinate values of the gravimetric center Cw are not integers, the coordinates of the nearest pixel position are obtained by rounding off to the nearest integer. Alternatively, coordinates obtained by rounding up or by any other prescribed rounding process may be set as the center Cs of the boundary concentration area.

Although the interpolated frames Fc, Fb in the first and second embodiments are obtained from a pair of frames F1 and F2, interpolated frames may be obtained from a set of three or more frames.

A frame interpolation apparatus has been described above, but the invention also includes the frame interpolation method implemented by this apparatus. The frame interpolation method may also be implemented by a suitably programmed computer, and the invention includes a machine-readable recording medium in which the program is stored.

Those skilled in the art will recognize that further variations are possible within the scope of the invention, which is defined in the appended claims.

What is claimed is:

1. A frame interpolation apparatus for generating an interpolated frame between a first frame and a second frame in a video signal from a set of frames including at least the first frame and the second frame, the second frame temporally preceding the first frame, the frame interpolation apparatus comprising:
a motion vector estimator for deriving motion vectors between the first frame and the second frame, based on the set of frames;
an interpolated frame generator for generating a motion-compensated interpolated frame based on the motion vectors obtained by the motion vector estimator; and
an interpolated frame corrector for correcting the motion-compensated interpolated frame generated by the interpolated frame generator; wherein
the interpolated frame corrector includes a motion vector boundary detector for detecting positions where an absolute value of a first derivative or a second derivative of the motion vectors obtained by the motion vector estimator is not less than a predetermined amount as a motion vector boundary, and corrects the motion-compensated interpolated frame on a basis of the motion vector boundary detected by the motion vector boundary detector.

2. The frame interpolation apparatus of claim 1, wherein the interpolated frame corrector further includes a correction map generator for generating an interpolated frame correction map indicating, as an area for correction, an area in which boundary pixels detected by the motion vector boundary detector are concentrated.

3. The frame interpolation apparatus of claim 2, wherein the interpolated frame corrector further includes a boundary concentration block detector that divides the frame into blocks of a predetermined size and designates each block including at least a predetermined proportion of boundary pixels as a boundary concentration block belonging to the area in which the boundary pixels are concentrated.

4. The frame interpolation apparatus of claim 3, wherein the interpolated frame corrector further includes a boundary concentration area determiner for designating a boundary concentration area centered on a geometric center of each boundary concentration block and outputting information indicating the designated boundary concentration area, and
the interpolated frame corrector corrects pixels in each boundary concentration area designated by the boundary concentration area determiner.

5. The frame interpolation apparatus of claim 3, wherein the interpolated frame corrector further includes a boundary concentration area determiner for designating a boundary concentration area centered on a gravimetric center of all boundary pixels in each boundary concentration block and outputting information indicating the designated boundary concentration area, and
the interpolated frame corrector corrects pixels in each boundary concentration area designated by the boundary concentration area determiner.

6. The frame interpolation apparatus of claim 4, wherein the interpolated frame corrector determines a size of the boundary concentration area from motion vectors surrounding each boundary concentration block.

7. The frame interpolation apparatus of claim 6, wherein the interpolated frame corrector determines a vertical size, Dc) of the boundary concentration area from a difference between vertical components of motion vectors of a pair of pixels disposed a predetermined distance above and below a center of the boundary concentration area, and determines a horizontal size of the boundary concentration area from a difference between horizontal components of motion vectors of a pair of pixels disposed a predetermined distance left and right of the center of the boundary concentration area.

8. The frame interpolation apparatus of claim 1, wherein the interpolated frame corrector corrects the motion-compensated interpolated frame by replacing pixel values of pixels targeted for correction with pixel values of a blended interpolated frame responsive to a degree of correction designated for the pixel targeted for correction,
the blended interpolated frame being generated by adding the pixel values of the first frame and the second frame together in proportions corresponding to a temporal phase of the interpolated frame.

9. The frame interpolation apparatus of claim 8, wherein the interpolated frame corrector performs replacement with the pixel value of the blended interpolated frame for each pixel targeted for correction responsive to the degree of correction that decreases gradually from a center to a periphery of an area targeted for correction.

10. The frame interpolation apparatus of claim 9, wherein:
the interpolated frame corrector further includes a boundary concentration area determiner that designates a boundary concentration area for each boundary concentration block in which pixels located at a motion vector boundary detected by the motion vector boundary detector are concentrated, and designates a degree of correction for each pixel in each designated boundary concentration area such that the degree of correction decreases gradually from the center toward the periphery of the boundary concentration area; and
when a pixel belongs to more than one boundary concentration area, the interpolated frame corrector performs the replacement with the pixel value of the blended interpolated frame by using a maximum one of the degrees of correction designated for the pixel by the boundary concentration area determiner.

11. A frame interpolation method for generating an interpolated frame between a first frame and a second frame in a video signal from a set of frames including at least the first frame and the second frame, the second frame temporally preceding the first frame, the frame interpolation method comprising:
a motion vector estimation step for deriving motion vectors between the first frame and the second frame, based on the set of frames;
an interpolated frame generation step for generating a motion-compensated interpolated frame based on the motion vectors obtained by the motion vector estimation step; and
an interpolated frame correction step for correcting the motion-compensated interpolated frame generated by the interpolated frame generation step; wherein
the interpolated frame correction step includes a motion vector boundary detection step for detecting positions where an absolute value of a first derivative or a second derivative of the motion vectors obtained by the motion vector estimation step is not less than a predetermined amount as a motion vector boundary, and corrects the motion-compensated interpolated frame on a basis of the motion vector boundary detected by the motion vector boundary detection step.

12. The frame interpolation method of claim 11, wherein the interpolated frame correction step further includes a correction map generation step for generating an interpolated frame correction map indicating, as an area for correction, an area in which boundary pixels detected by the motion vector boundary detection step are concentrated.

13. The frame interpolation method of claim 12, wherein the interpolated frame correction step further includes a boundary concentration block detection step that divides the frame into blocks of a predetermined size and designates each block including at least a predetermined proportion of boundary pixels as a boundary concentration block belonging to the area in which the boundary pixels are concentrated.

14. The frame interpolation method of claim 13, wherein the interpolated frame correction step further includes a boundary concentration area determination step for designating a boundary concentration area centered on a geometric center of each boundary concentration block and outputting information indicating the designated boundary concentration area, and
the interpolated frame correction step corrects pixels in each boundary concentration area designated by the boundary concentration area determination step.

15. The frame interpolation method of claim 13, wherein the interpolated frame correction step further includes a boundary concentration area determination step for designating a boundary concentration area centered on a gravimetric center of all boundary pixels in each boundary concentration block and outputting information indicating the designated boundary concentration area, and
the interpolated frame correction step corrects pixels in each boundary concentration area designated by the boundary concentration area determination step.

16. The frame interpolation method of claim 14, wherein the interpolated frame correction step determines a size of the boundary concentration area from motion vectors surrounding each boundary concentration block.

17. The frame interpolation method of claim 16, wherein the interpolated frame correction step determines a vertical size of the boundary concentration area from a difference between vertical components of motion vectors of a pair of pixels disposed a predetermined distance above and below a center of the boundary concentration area, and determines a horizontal size of the boundary concentration area from a difference between horizontal components of motion vectors of a pair of pixels disposed a predetermined distance left and right of the center of the boundary concentration area.

18. The frame interpolation method of claim 11, wherein the interpolated frame correction step corrects the motion-compensated interpolated frame by replacing pixel values of pixels targeted for correction with pixel values of a blended interpolated frame responsive to a degree of correction designated for the pixel targeted for correction,
the blended interpolated frame being generated by adding the pixel values of the first frame and the second frame together in proportions corresponding to a temporal phase of the interpolated frame.

19. The frame interpolation method of claim 18, wherein the interpolated frame correction step performs replacement with the pixel value of the blended interpolated frame for each pixel targeted for correction responsive to the degree of correction that decreases gradually from a center to a periphery of an area targeted for correction.

20. The frame interpolation method of claim 19, wherein:
the interpolated frame correction step further includes a boundary concentration area determination step that designates a boundary concentration area for each boundary concentration block in which pixels located at a motion vector boundary detected by the motion vector boundary detection step are concentrated, and designates a degree of correction for each pixel in each designated boundary concentration area such that the degree of correction decreases gradually from the center toward the periphery of the boundary concentration area; and
when a pixel belongs to more than one boundary concentration area, the interpolated frame correction step performs the replacement with the pixel value of the blended interpolated frame by using a maximum one of the degrees of correction designated for the pixel by the boundary concentration area determination step.

21. A computer-readable recording medium storing a program executable to perform frame interpolation by the method of claim 11.
